(19) United States
(12) Patent Application Publication
(10) Pub. No.: US 2008/0159479 A1
(43) Pub. Date: Jul. 3, 2008

(54) WIDE PARALLEL BEAM DIFFRACTION IMAGING METHOD AND SYSTEM

(75) Inventors: Huapeng HUANG, Latham, NY (US); Walter M. Gibson, Voorheesville, NY (US)

Correspondence Address: HESLIN ROTHENBERG FARLEY & MESITI PC, 5 COLUMBIA CIRCLE, ALBANY, NY, 12203, US

(73) Assignee: X-RAY OPTICAL SYSTEMS, INC., East Greenbush, NY (US)

(21) Appl. No.: 11/837,119

(22) Filed: Aug. 10, 2007

Related U.S. Application Data
(60) Provisional application No. 60/836,714, filed on Aug. 10, 2006.

(51) Int. Cl. G01N 23/207

(52) U.S. Cl. 378/73

(57) ABSTRACT

An x-ray diffraction technique (apparatus, method and program products) for measuring crystal structure from a large sample area. The measurements are carried out using a large size collimating optic (up to 25 mm or more in diameter or corresponding cross-section) along with a 2-dimensional x-ray image detector. The unique characteristics of polycapillary collimating optics enable an efficient x-ray diffraction system (either low power or high power) to measure a large portion (or even the whole sample surface area) of the sample to obtain critical crystal structure information, such as the orientation of the whole sample, defects in the crystal, the presence of a secondary crystal, etc. Real-time, visual monitoring of the detected diffraction patterns is also provided. Turbine blade crystal structure measurement examples are disclosed.

### CROSS-REFERENCE TO RELATED APPLICATIONS

This application claims the benefit of U.S. Provisional Application No. 60/836,714, filed Aug. 10, 2006. This Provisional Application is hereby incorporated herein by reference in its entirety.

### GOVERNMENT RIGHTS STATEMENT

This invention was made with Government support under Contract # FA8103-05-C-0165 awarded by the United States Department of Defense to X-Ray Optical Systems, Inc. The Government has certain rights in this invention.

### TECHNICAL FIELD

This invention relates in general to x-ray diffraction. More particularly, the present invention relates to a technique for wide beam x-ray diffraction for imaging applications.

### BACKGROUND OF THE INVENTION

X-ray analysis techniques have been some of the most significant developments in science and technology. The use of x-ray diffraction, spectroscopy, imaging, and other x-ray analysis techniques has led to a profound increase in knowledge in virtually all scientific fields.

One existing class of surface analysis is based on diffraction of x-rays from a sample. The diffracted radiation can be detected and various physical properties, including crystalline structure, orientation, phase, and size, can be algorithmically determined. These measurements can be used for process monitoring in a wide variety of applications, including the manufacture of semiconductors, pharmaceuticals, specialty metals and coatings, building materials, and other crystalline structures.

Directionally solidified nickel super-alloys are commonly used in turbine blades for high temperature propulsion and power generation applications. The casting of these parts does not always assure perfect grain orientation, which is critical for their performance under high temperature. There is a great deal of interest in recent engine failures and aircraft mishaps due to failure of these parts. There is an imperative requirement for the ability to verify the grain orientation of fabricated single crystal and directionally solidified turbine blades. This needs to be measured at the time of manufacturing for quality assurance, and/or when the turbine is returned for service.

One of the greatest obstacles in the quality assurance process for single crystal nickel based alloy turbine blades is determination of the overall crystalline perfection of the entire blades. A commonly used quality control method consists of chemical etching and visual inspection. The problems associated with visual inspection are self evident (subjectivity, reliability, precision, etc.). In addition there are other problems associated with the etching process.

Currently, the crystal orientation may be determined by “Laue” x-ray back diffraction from selected single points on the blade. X-ray diffraction is a traditional and standard non-destructive method to measure crystal grain orientation.

X-ray diffraction occurs when an incident x-ray beam and crystal orientation strictly meet the Bragg condition with respect to a crystal plane (2*d* sin (θ)=k*), where d is the distance of crystal plane spacing; θ is the incident angle; k is a natural number and λ is the wavelength of the incident x-ray). It is usual to measure the orientation of crystals by manipulating the orientation of the crystal to meet the Bragg condition. Current x-ray diffraction techniques suffer from the limitation that they are point-based, i.e., they can only perform a point-by-point analysis of a surface, whereby each point is about 1 mm in diameter.

What is required, therefore, are techniques, methods and systems which exploit the benefits of x-ray diffraction measurements for larger areas of a sample.

### SUMMARY OF THE INVENTION

The shortcomings of the prior art are overcome and additional advantages are provided through the present invention which in one aspect is an x-ray diffraction technique (apparatus, method and program product) for measuring crystal structure from a large sample area. The measurements are carried out using a large size (up to 25 mm or more in diameter or corresponding cross-section) collimating optic along with a 2-dimension x-ray image detector. In that regard, the present invention in one aspect is an x-ray diffraction apparatus for measuring a characteristic of a sample, having an x-ray source for emitting substantially divergent x-ray radiation; a polycapillary or curved crystal collimating optic disposed with respect to the x-ray source for producing a substantially parallel beam of x-ray radiation by receiving and redirecting the divergent paths of the divergent x-ray radiation toward an area of the sample; and an x-ray imaging detector for collecting a diffraction profile from the area of the sample toward which the x-ray radiation is directed. The parallel beam may be at least 5 mm in diameter or corresponding cross-sectional area; or 15 mm or more in diameter or corresponding cross-sectional area. A second optic may follow the collimating optic to further increase the beam size; possibly an asymmetrically cut crystal having its mosaicity of the second optic controlled to thereby control local divergence of the beam.

A display device may be provided for a real-time display of the diffraction profile from the area of the sample; and the sample and the source/detector may be translatable relative to one another.

The unique characteristics of polycapillary collimating optics enable an efficient x-ray diffraction system (either low power or high power) to measure a large portion (or even the whole sample surface area) of the sample to obtain critical crystal structure information, such as the crystal orientation of the whole sample, defects in the crystal, the presence of a secondary crystal, etc.

Preliminary crystal orientation information could be obtained from Laue diffraction, to quickly set the sample to the measurement position for large parallel beam diffraction measurements.

Several possible approaches are also proposed for automatic image processing. The combination of the polycapillary collimating optic with asymmetrically cut (single or mociasity) crystal can further expand the beam size.

An exemplary application—examination of turbine blade defects—is presented, but this technique could be useful in a variety of industrial application fields, including any environments where orientation, defects, or other crystallographic information are required.

### BRIEF DESCRIPTION OF THE DRAWINGS

The subject matter regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic view of an x-ray diffraction imaging system according to one aspect of the present invention;

FIG. 2a depicts a turbine blade and a corresponding diffraction image thereof in accordance with the present invention;

FIG. 2b depicts a real-time image of a diffraction image produced according to the principles of the present invention;

FIGS. 3a-c depict an electron bombardment source, polycapillary collimating optic, and source/optic combination optimized for use in the x-ray diffraction system of the present invention; and

FIG. 4 depicts an asymmetrically cut crystal following the polycapillary optic to expand the beam size.

### DETAILED DESCRIPTION OF THE INVENTION

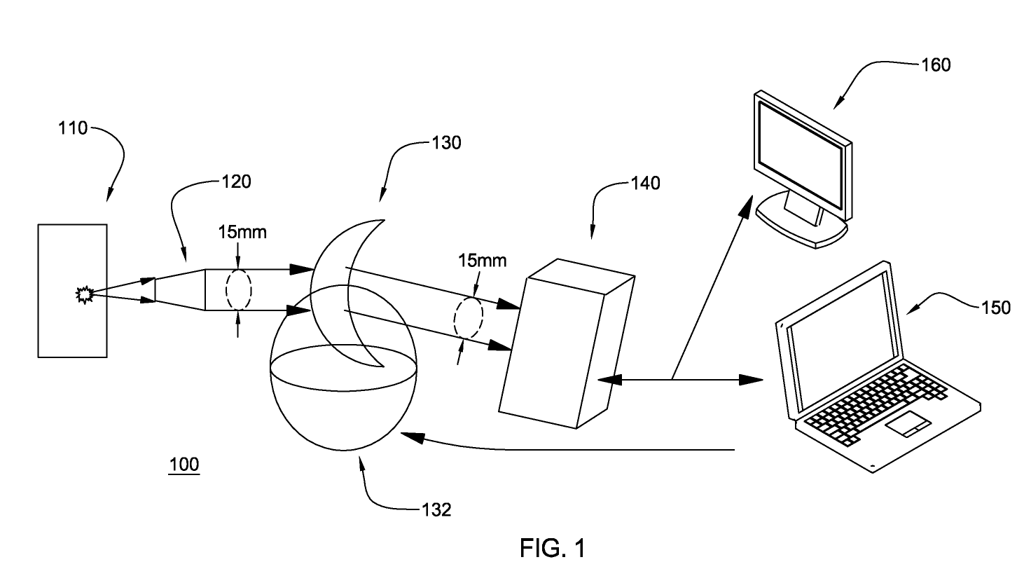

The present invention relates to a wide beam diffraction system 100 as depicted in FIG. 1 for diffraction imaging applications. The wide incident beam is, e.g., 5-25 mm or more in diameter or corresponding cross-sectional area—here 15 mm in diameter as an example. An x-ray source 110 produces a divergent beam which is collimated by collimating optic 120 into the relative large beam (greater than 5 mm, here 15 mm). This beam illuminates a large area of sample 130 (e.g., a turbine blade), which can be mounted on a rotation/translation stage 132. The diffraction is detected by an imaging detector 140 and provided to a real time display 160 and/or a processing computer 150. Imaging detector, as known to those skilled in the art, can detect and process the entire diffraction profile simultaneously, from the illuminated area of the sample. Therefore, a large area diffraction profile is provided by the present invention (in contrast to the point-by-point techniques of the prior art).

Although convergent beams may have some unique characteristics, such as the ability to measure a small spot and a broader angular range, the small measurement area and sensitivity to sample surface position, geometry, and shape are not suitable for diffraction imaging of larger sample areas. Parallel beam diffraction imaging, especially using large uniform parallel beams coupled with cheaper, low power sources, offer an exciting and promising opportunity for the development of low-power diffraction systems solving many requirements. For example, a proprietary collimating polycapillary optic in a system utilizing a compact, low-power (less than 100 W), provides a highly stable, reliable and safe system with a large area, uniform, quasi-parallel (˜0.3 degree divergence) collimated beam, and a two-dimensional imaging detector.

One exemplary optic is about 15 mm diameter beam size, with a 50 mm input focal distance from source spot and about 170 mm² output beam size. It can provide up to 1.2×10¹⁰ Cu Kα total parallel beam photons per second with a 40W Cu anode x-ray tube.

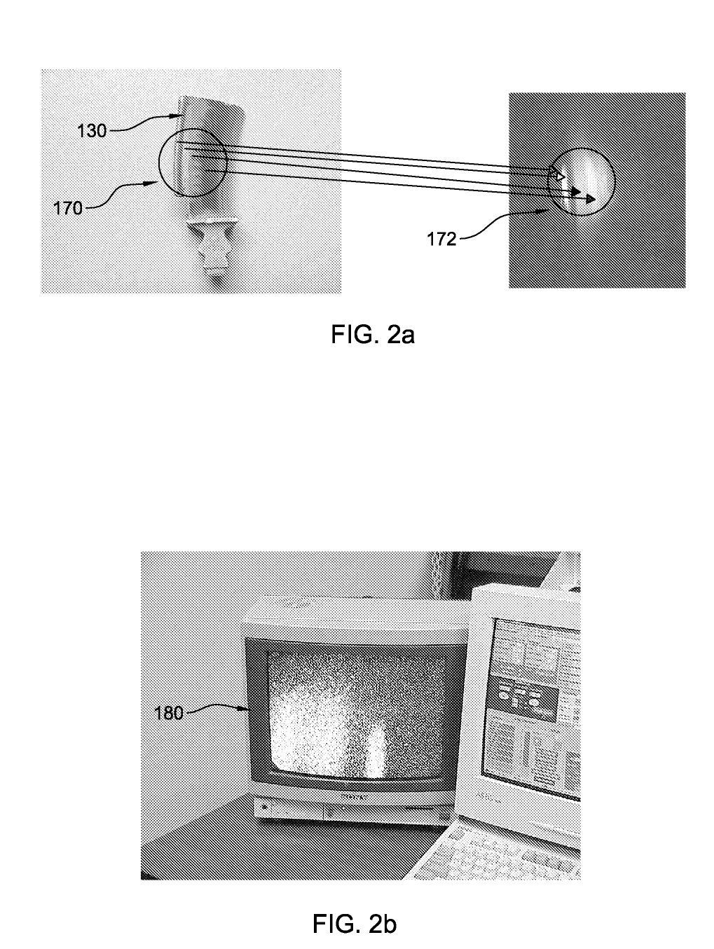

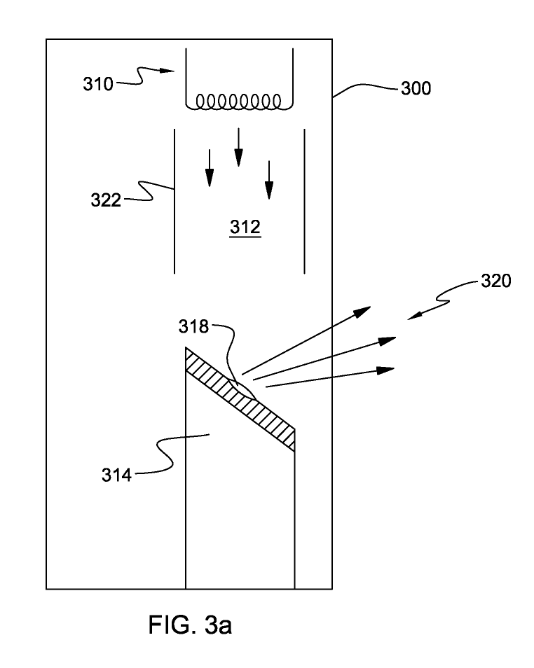

Measurement of the intensity distribution of the large area diffracted beam can provide crystalline information about the sample. For a uniform beam diffracted from a perfect single crystal, the intensity distribution will be uniform, and may even show the sample shape if the beam is larger than the sample. Films or any other suitable analog or digital media can be used to record the diffraction from a turbine blade sample 130, and a detailed view of the turbine blade and the diffracted image showing the relative position relationships (170/172) is shown in FIG. 2a. The Cu x-ray source can be run at 40 W (40 kV, 1 mA) and the exposure time was 1˜2 minutes. The beam can be approximately 15 mm in diameter or about 176 mm² in corresponding cross-sectional area, and incident on an even larger portion 170 of this sample depending on the angle of incidence (here, e.g., 17 degrees). A smaller angle of incidence provides a much larger beam footprint on the sample.

FIG. 2a clearly demonstrates that this diffraction method can measure the crystal quality of a large portion of a turbine blade, based on the differing diffraction patterns detected corresponding to different portions of the blade. If the blade is not a single crystal, rotation scanning of the blade will cause other grains to light up and the amount of the rotation will directly indicate the mismatch between the grain orientation. These and other effects provide very useful measurement results. For the turbine blade example herein, coatings should be removed for proper analysis, or the analysis should occur prior to a coating step.

Real time x-ray diffraction crystal quality measurements are also possible as shown in FIG. 2b by using an x-ray image intensifier and a TV monitor 180 or other real-time imaging device.

During this measurement, the x-ray source was operated at full power 40 kV, 1 mA (40W). A {110} diffraction peak from a large portion of the turbine blade sample showed clearly, in real time, on the TV monitor. By remote translation scanning of the turbine blade sample relative to the x-ray engine/imaging system (e.g., source/optic/detector), it is possible to create whole blade orientation measurements in several minutes. This relative movement can be effected by movement of the sample itself on translation stages, or, advantageously, movement of the x-ray engine (source/optic and/or detector) relative to the sample, which is possible using the small, low power, stabilized electron bombardment sources discussed further below. The value of such measurements on blades as they are removed from their casting, as well as following further mechanical or laser peening or other surface treatment, is self-evident. (It should be noted that small beam cross section Laue diffraction patterns can be made with the same large area collimating optic by simply adding an aperture (1˜2 mm pinhole) at the output of the optic for the preliminary crystal orientation determination.)

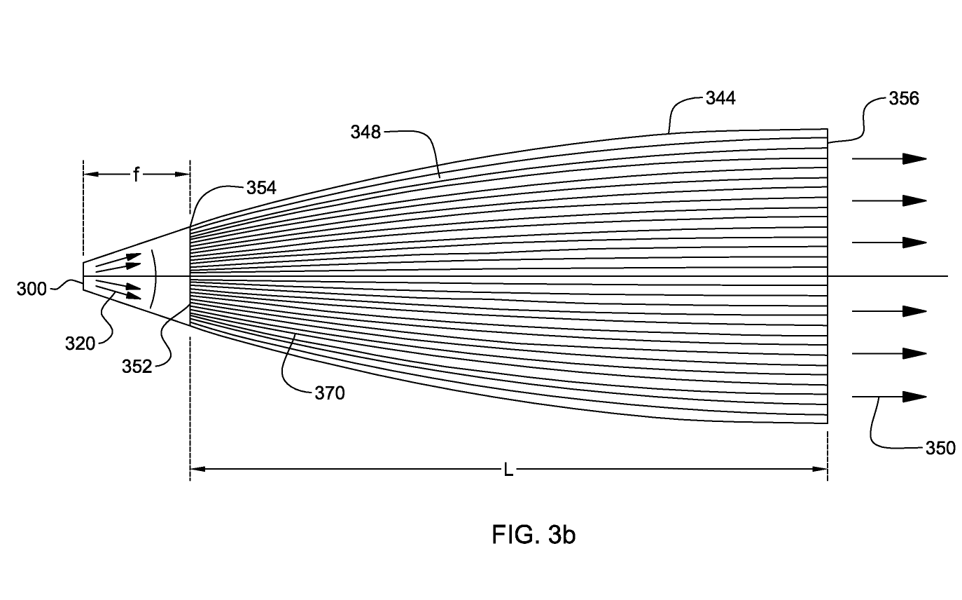

These results are enabled by a number of exemplary advantageous features of the system:
The high intensity of the collimated beam, enabled by the large collection angle and high transmission efficiency of the polycapillary collimated optic. Even for a small cross section beam as that used for the Laue diffraction pattern measurements, the beam intensity for the 40 W source used is comparable to that obtained with conventional laboratory x-ray generators of several kW power.
The (local) divergence of the collimated beam. For the example, as discussed here this divergence depends on the x-ray energy (and also depends on optic material choice, design, etc.) and may be about 0.2-0.3 degrees for Cu Ka (8.0 keV) x-rays and about 0.12 degrees for Mo Ka x-rays. A smaller beam divergence enables precise measurement but with more alignment constraints, however, the more moderate beam divergence here (0.2-0.3) allows looser alignment constraints to speed up the rotation alignment process.
Insensitivity to sample position, and shape, and to some degrees of surface roughness because of the parallel beam, in contrast to the strong dependence on sample position, surface flatness and smoothness in conventional Bragg-Brentano x-ray diffraction systems.
The large cross section parallel beams, with high intensity, that are possible with carefully designed polycapillary optics, making large area mapping of crystal orientation and quality possible.
The small size, low cost, reliability, high stability, safety and flexibility of a coupled source-optic X-Beam source system, as discussed further below, with reference to FIGS. 3a-c.

As discussed above, the ability to provide an improved, lower cost analysis capability depends to a large extent upon source/optic technology. In that regard, certain source and optic technology formerly disclosed and assigned to the assignee of the present invention can be optimized for use here, as discussed below with respect to FIGS. 3a-c.

Referring now to FIG. 3a, the basic elements of a typical compact, low cost electron-bombardment x-ray source 300 are shown (e.g., Oxford 5011). Electron gun/filament 310 is heated (by applying a voltage) to a temperature such that electrons 312 are thermally emitted. These emitted electrons are accelerated by an electric potential difference to anode 314, which is covered with target material, where they strike within a given surface area of the anode, called the spot size 318. Divergent x-rays 320 are emitted from the anode as a result of the collision between the accelerated electrons and the atoms of the target. To control the spot size, electromagnetic focusing means 322 may be positioned between filament 310 and anode 314.

With reference to FIG. 3b, producing the requisite x-ray beam requires, for example, that the x-ray source 300 be coupled to a monolithic, polycapillary collimating optic 344. These two components are usually separated by a distance f, known as the focal distance. The optic 344 comprises a plurality of hollow glass capillaries 348 fused together and shaped into configurations which allow efficient capture of divergent x-ray radiation 320 emerging from x-ray source 300. In this example the captured x-ray beam is shaped by the optic into a substantially parallel beam 350. The channel openings 352 located at the optic input end 354 are roughly pointing at the x-ray source. The ability of each individual channel to essentially point at the source is of significant importance for several reasons: 1) it allows the input diameter of the optic to be sufficiently decreased, which in turn leads to the possibility of smaller optic output diameters; 2) it allows capture of a large solid angle from the source; and 3) it makes efficient x-ray capture possible for short optic to source focal lengths. The diameters of the individual channel openings 352 at the input end of the optic 354 may be smaller than the channel diameters at the output end of the optic 356.

This type of optic redirects the otherwise divergent x-rays from the source into the output, parallel beam 350. This not only ensures maximal efficiency, but provides some immunity to displacement of the sample under study in the x-ray diffraction systems discussed above. To use the large size x-ray beam for turbine blade imaging, uniformity is a critical issue. A highly uniform output of the optic is generally a requirement for this application.

A typical large size polycapillary optic is made of more than 500,000 small capillary tubes. The curvature and position of this large amount of capillaries must be precisely controlled to achieve optic highly uniform performance. These capillaries are arranged to efficiently collect x-rays from an x-ray source with a large capture angle (up to 30°) and with high efficiency (10% to 50%) for x-ray energies typically used for XRD. The shaped bundles of capillaries produce a quasi-parallel beam leading to greatly increased efficiency for x-ray diffraction applications. Compared with other types of X-ray optics, polycapillary optics can provide a high intensity and large beam size with moderate 0.20 beam divergence. This beam divergence is suitable for most XRD measurements, which do not require extremely high resolution. The achievable large beam size from polycapillary collimating optics makes the x-ray diffraction measurements more reliable and efficient.

Parallel beams are also less susceptible to sample displacements—a significant advantage when operating in an in-situ environment, or on curved sample surfaces.

Angular filter(s) can be used after the sample to limit angles of critical energy reaching the detector. Scattering can be controlled from unwanted angles, thus controlling the area of the sample from which energy is detected. Controlling the critical angle and other design parameters of the angular filters accordingly is useful in the present invention, to ensure that the maximal signal-to-noise ratio from the sample is collected. Other types of angular filters are possible, including soller slits, multi-channel plates, etc. One- or two-dimensional alternatives can also be used.

Other collimating optics may be used, i.e., those which receive a wide angle of divergent x-rays and redirect the divergent rays into a parallel beam. Such optics include, for example, curved crystal optics (see e.g., X-Ray Optical, Inc. U.S. Pat. Nos. 6,285,506; 6,317,483; and 7,035,374—all of which are incorporated by reference herein in their entirety), or multilayer optics. Collimating optic may also be a soller slit collimator, which is an array of thin absorbing plates separated by gaps. A pinhole collimator is also possible, but that is also an inefficient technique.

FIG. 3c illustrates in cross-section an elevational view of one embodiment of an x-ray source/optic assembly particularly suited for the diffraction systems of the present invention. The x-ray source/optic assembly includes an x-ray source 300′ and an output optic 344′ - similar to those discussed above with respect to FIGS. 3a-b. Optic 344′ is aligned to x-ray transmission window 2107 of vacuum x-ray tube 2105. X-ray tube 2105 houses electron gun/filament 2115 arranged opposite to high voltage anode 2125. When voltage is applied, electron gun 2115 emits electrons in the form of an electron stream 2120 (as described above). HV anode 2125 acts as a target with respect to a source spot upon which the electron stream impinges for producing x-ray radiation 2130 for transmission through window 2107 and collection by optic 344′.

Anode 2125 may be physically and electrically connected to a base assembly which includes a conductor plate 2155 that is electrically isolated from a base plate 2165′ via a dielectric disc 2160. A high voltage lead 2170 connects to conductive plate 2155 to provide the desired power level to anode 2125. The electron gun 2115, anode 2125, base assembly 2150 and high voltage lead 2170 may be encased by encapsulant 2175 all of which reside within a housing 2710. (However, dielectric disk 2160 functions to remove excess heat from the assembly, in one embodiment negating the need for any special cooling encapsulants). Housing 2710 includes an aperture 2712 aligned to x-ray transmission window 2107 of x-ray tube 2105. In operation, x-ray radiation 2130 is collected by optic 344′, and in this example, redirected into a substantially parallel beam 350.

A control system may also be implemented within x-ray source assembly 300′. This control system includes, for example, a processor 2715, which is shown embedded within housing 2710, as well as one or more sensors and one or more actuators (such as sensor/actuator 2720 and actuator 2730), which would be coupled to processor 2715. This control system within x-ray source assembly 300′ includes functionality to compensate for, for example, thermal expansion of HV anode 2125 and base assembly 2150 with changes in anode power level or changes in ambient temperature in order to maintain an alignment of x-rays 2130 with respect to optic 2135. This enables the x-ray source assembly 2700 to maintain a spot size 2745 with stable intensity within a range of anode operating levels.

This parallel beam production and transmission can be effected by the polycapillary collimating optics and optic/source combinations such as those disclosed in commonly assigned, X-Ray Optical Systems, Inc. U.S. Pat. Nos. 5,192,869; 5,175,755; 5,497,008; 5,745,547; 5,570,408; and 5,604,353; U.S. Provisional Applications Ser. No. 60/398,968 (filed Jul. 26, 2002 and perfected as PCT Application PCT/US02/38803, now U.S. Pat. No. 7,110,506) and 60/398,965 (filed Jul. 26, 2002 and perfected as PCT Application PCT/US02/38493, now U.S. Pat. No. 7,209,545)—all of which are incorporated by reference herein in their entirety.

For in-situ XRD applications, the stability, safety (due to internal shielding and an internal shutter-interlock system), and compactness as well as the ability to operate in any arbitrary orientation is particularly important. The small size of the disclosed source makes it easily adaptable to most measurement geometries and environments. Because the low-power tube is coupled with a polycapillary collimating optic with a short input focal distance, it can provide a high-intensity quasi-parallel x-ray beam. For example, with 50 Watts power and a 4 mm diameter collimating beam size, it can provide up to 3×10⁹ Cu Kα photons/sec. This is comparable to the intensity of a much more expensive, laboratory based, conventional 5 kW rotating anode x-ray source equipped with state-of-art-confocal x-ray optics. 15 mm or even larger collimated beams with correspondingly higher intensity are also possible.

A proper x-ray image detector can be selected based on the performance requirements. This detector is a significant component of this invention. This detector must meet certain requirements such as detector size, capture area size, spatial resolution, image frame reading rate, signal-noise ratio, counting rate, dynamic range, etc. An x-ray image intensifier can be used to demonstrate feasibility and is also a natural detection option. If it could meet the requirements for image processing, other type of image intensifier and other types of x-ray image detectors can be used, such as multiwire area detector or CCD-based two dimensional detector.

A crack in the surface or a boundary in the sample with the second crystal should be easily detected with this invention. Because of the compact package of the above-described system, the whole system can be a compact bench-top system with a small footprint. To achieve this goal, the image detector and sample handling system should also be of small size.

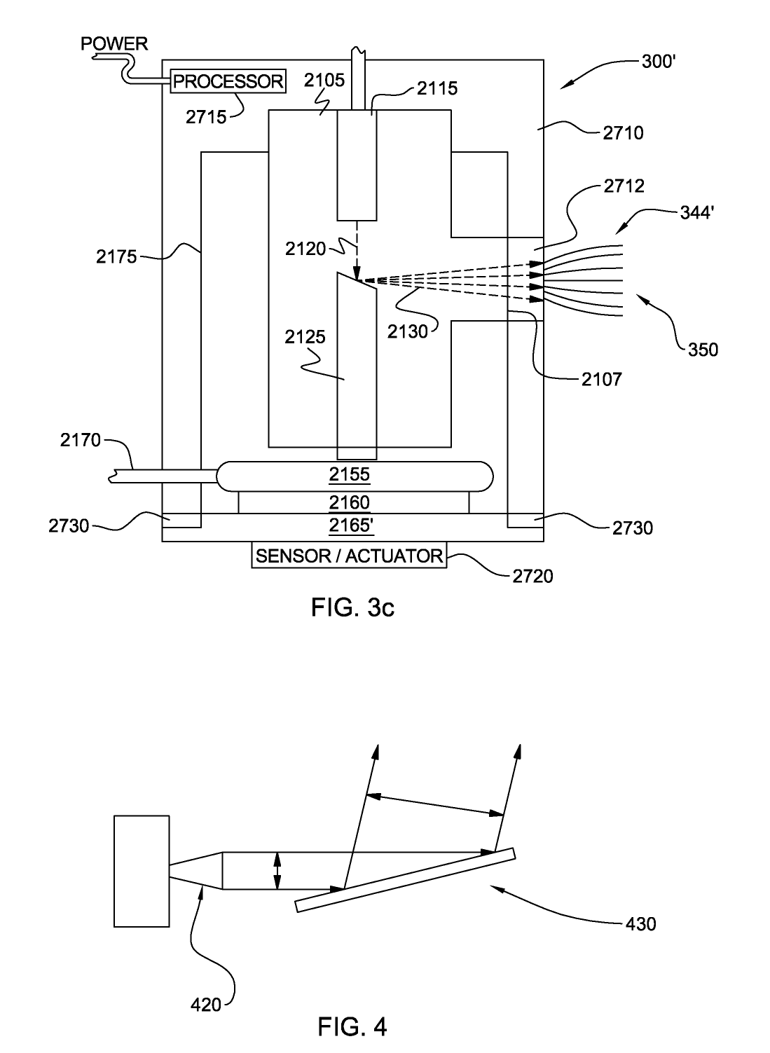

In an improved embodiment, and with reference to FIG. 4, an asymmetrically cut, perhaps mosaic crystal 430, is provided to further increase the incident beam size from polycapillary optic 420. This involves using a tilting cut crystal to increase the incident beam size for imaging a larger surface of the sample (e.g., blade) without translational scanning. This method could speed up the measurements and largely simplify the image processing. For example, if the offset angle is set at 10° for Germanium wafer used with Cu Kα radiation, the beam size will be increased by a factor of 6. So the expanded beam size will become 90 mm in diameter if the collimated parallel beam from the optic is 15 mm. The nearly 100 mm beam can cover an entire turbine blade for x-ray diffraction imaging. The key issue here is to understand the beam intensity and uniformity after its cross section size has been significantly increased.

In addition, different crystal mosaicities of crystal 430 can be used to control the local divergence, which impacts system resolution. When local divergence is decreased, the resolution is increased.

### Software Development for Image Processing

Various software partitions may be provided. The first is for processing the diffraction pattern for an approximate crystal orientation measurement. The second is for determining the crystal quality once the orientation is known. The purpose of the Laue and crystal quality image processing software is to enable the system to automatically check the orientation of the whole turbine blade and its crystalline quality. Crystal orientation obtained from Laue type x-ray diffraction measurements can be used to quickly set the sample to the measurement position for large beam diffraction measurements discussed above.

Detailed 3-dimentional structure data for each sample type can be obtained. Simulation patterns can be compared with the real-time collected diffraction patterns. A special algorithm can be used to detect any anomalies or defects in each sample. These may include secondary crystals, cracks, or crystalline quality issues highlighted by evaluating the comparison of real-time measurement image data and simulation data. For example, the system can provide a coded rank number of turbine blade crystal quality and provide a warning message for quality control if there is a serious defect. Uniformity analysis, such as intensity deviation analysis or image-edge finding, might be applied for the development of defect detection.

When the 3-dimentional structure data of the turbine blade is not available, a video camera or other real-time capture and display device can be used to take a quick shot of the turbine blade from a corresponding position to provide a baseline image for the data comparison processing noted above. This has obvious application on the manufacturing floor for a quick check. It is by no means quantitative, but it is capable of illuminating warning signs in a real time production environment.

With the characteristic of polycapillary collimating optic of moderate 0.2-0.3 degree beam divergence, the sample positioning for large beam measurements can be obtained after the preliminary information about the crystal orientation is known.

The term “in-situ” as used herein connotes applications where the sample exists in its own environment, including under active production. Examples include an “in-line” system, coupled directly to a production line and analyzing material as it exists (possibly moving) in the production line in a substantially predictable state; or an “at-line” system which is closely associated with the production line, but which analyzes samples removed from their production line with minimal sample preparation prior to measurement; or an “on-site” system which can be portably transported to a site at which the sample resides in a substantially predictable state; but generally exclude “off-line,” fixed laboratory environments. The term “production” herein connotes active production or transformation of a material in a production facility, including reviewing materials in their native state (i.e., at an ore mine) at the time their initial transformation occurs.

Other “in-situ” environments are contemplated by the present invention. For example, an “on-site” system which can be portably transported to a site at which the sample resides in a substantially predictable state (e.g., an ore mine where certain characteristics of the samples are of interest; or forensic scenes where certain known materials are being sought).

The processing portions of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

Any flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

The object of the invention is achieved by features of the independent claims. Other embodiments are disclosed in the dependent claims. Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. An x-ray diffraction apparatus for measuring a characteristic of a sample, comprising:
an x-ray source for emitting substantially divergent x-ray radiation;
a polycapillary collimating optic disposed with respect to the x-ray source for producing a substantially parallel beam of x-ray radiation by receiving and redirecting the divergent paths of the divergent x-ray radiation toward an area of the sample; and
an x-ray imaging detector for collecting a diffraction profile from the area of the sample toward which the x-ray radiation is directed.

2. The apparatus of claim 1, wherein the parallel beam is at least 5 mm in diameter or corresponding cross-sectional area.

3. The apparatus of claim 2, wherein the parallel beam is 15 mm or more in diameter or corresponding cross-sectional area.

4. The apparatus of claim 1, further comprising a second optic following the polycapillary optic to further increase the beam size.

5. The apparatus of claim 4, wherein the second optic is an asymmetrically cut crystal.

6. The apparatus of claim 5, wherein mosaicity of the second optic is controlled to thereby control local divergence of the beam.

7. The apparatus of claim 1, further comprising a display device for a real-time display of the diffraction profile from the area of the sample.

8. The apparatus of claim 1, further comprising an angular filter between the sample and the detector.

9. The apparatus of claim 1, further comprising the sample, wherein the sample is a turbine blade.

10. The apparatus of claim 1, wherein the sample and the source/detector are translatable relative to one another.

11. An x-ray diffraction apparatus for measuring a characteristic of a sample, comprising:
an x-ray source for emitting substantially divergent x-ray radiation;
a curved crystal collimating optic disposed with respect to the x-ray source for producing a substantially parallel beam of x-ray radiation by receiving and redirecting the divergent paths of the divergent x-ray radiation toward an area of the sample; and
an x-ray imaging detector for collecting a diffraction profile from the area of the sample toward which the x-ray radiation is directed.

12. The apparatus of claim 11, wherein the parallel beam is at least 5 mm in diameter or corresponding cross-sectional area.

13. The apparatus of claim 12, wherein the parallel beam is 15 mm or more in diameter or corresponding cross-sectional area.

14. The apparatus of claim 1, further comprising a second optic following the polycapillary optic to further increase the beam size.

15. The apparatus of claim 14, wherein the second optic is an asymmetrically cut crystal.

16. The apparatus of claim 15, wherein mosaicity of the second optic is controlled to thereby control local divergence of the beam.

17. The apparatus of claim 11, further comprising a display device for a real-time display of the diffraction profile from the area of the sample.

18. The apparatus of claim 11, further comprising an angular filter between the sample and the detector.

19. The apparatus of claim 11, further comprising the sample, wherein the sample is a turbine blade.

20. The apparatus of claim 11, wherein the sample and the source/detector are translatable relative to one another.
